(19) United States
(12) Patent Application Publication
(10) Pub. No.: US 2006/0156308 A1
(43) Pub. Date: Jul. 13, 2006

(54) Deadlock-prevention system

(76) Inventors: Thomas C. Jarvis, Tucson, AZ (US); Kenneth W. Todd, Tucson, AZ (US)

Correspondence Address: QUARLES & BRADY STREICH LANG LLP, 1 SOUTH CHURCH AVENUE, SUITE 1700, TUCSON, AZ, 85701, US

(21) Appl. No.: 11/031,854

(22) Filed: Jan. 7, 2005

(51) Int. Cl. G06F 9/46

(52) U.S. Cl. 718/104

(57) ABSTRACT

A deadlock-prevention system includes a resource-access key passed from a parent process to a spawned process that includes the parent processes' level of access to a system resource. Optionally, the resource-access key includes a shared-access request based on the expectation by the parent process that the child process will need shared-access to a system resource. The resource-access key is presented by the child process to a resource-allocation algorithm. The resource-allocation algorithm identifies the resource-access key, allows the child process to bypass a resource-allocation queue, and grants shared access to the resource to the child process, preventing deadlock.

### BACKGROUND OF THE INVENTION

1. Field of the Invention

This invention is related in general to deadlock-prevention systems. In particular, the invention consists of a system to recognize when a computational process may bypass a queue for access to a system resource.

2. Description of the Prior Art

Data storage systems are often employed to transfer data from one computer system or server to another. To facilitate this transfer of information, computational and communication resources are often shared by a plurality of computer systems. For example, hard-disk drives are often combined into redundant arrays of inexpensive/independent disks (“RAIDs”). These arrays are usually striped to increase reliability, redundancy, and data integrity. While each hard-disk drive is associated with a physical address within the computer system, the array is often partitioned into logical volumes. Each logical volume is associated with a virtual (logical) address. These volumes are often divided into logical tracks, i.e., predefined contiguous memory locations. Multiple computer systems or servers may access the volumes and tracks in order to read or write information.

Some transactions on these volumes may occur concurrently. For example, two computer systems may read data from the same track at the same time, thereby sharing access to the resource (track). Other transactions, however, may not be able to occur concurrently, such as writing data to the track. Multiple simultaneous writes to the same track will produce corrupt data. Additionally, if a read operation and a write operation are performed by the same physical apparatus, such as a drive-head, a contention would occur for access to the drive-head. Accordingly, these transactions require exclusive access to their respective resources. In order to prevent contentions between processes seeking exclusive access, resource-allocation algorithms are traditionally employed to regulate access to computer system resources.

In one application of a resource-allocation algorithm, an out-of-synch (“OOS”) bitmap is used to regulate asynchronous peer-to-peer remote copy (“PPRC”). Each bit in the OOS represents a track in a primary system which has been written to, but has not yet passed its data to a secondary system. In an asynchronous PPRC, write processes occur randomly to primary system tracks. Concurrently, non-random read processes check the OOS for tracks which have been written to, read the corresponding tracks, and send the corresponding data to the secondary system.

In order to create a consistent copy of the primary system, all tracks which have been written to are periodically copied en masse to the secondary system. This is accomplished by freezing the OOS, i.e., refraining from setting bits indicating that a new write transaction has occurred, and reading all tracks which have bits set in the OOS. Simultaneously, new write transactions are indicated in an alternate bitmap designated the change-recording bitmap (“CR”). A collision occurs when a track which has already been written to, as indicated in the OOS, is written to again before the original written data is passed to the secondary system. Collisions produce corrupted data, as indicated above. Accordingly, it is desirable to prevent collisions.

A queue may be utilized to prevent collisions. For example, a resource-allocation algorithm may manage a track-access queue by applying ordering rules. These ordering rules regulate read and write transactions to the volume tracks. These transactions are usually added to the queue on a first-come basis, and each queued transaction is identified as either a shared transaction or an exclusive transaction. The resource-allocation algorithm may grant multiple simultaneous accesses to shared transactions while requiring exclusive transactions to wait for their turn to access the associated resource.

A problem may occur when a process generates a sub-process, such as a parent process spawning a child process, and both the processes need access to the same resource. Once the child process is spawned, the parent process will suspend and wait for the child process to complete and terminate. If the parent process and child process both generate a shared transaction request for the resource (track), then no problem occurs. The resource-allocation algorithm simply grants the child process shared access to the resource, the child process finishes its task and terminates, and then parent process accesses the resource. However, if the parent process has been granted exclusive access to a resource that is needed by the child process, the child process cannot access the resource, cannot complete, and will not terminate. This results in procedural deadlock, with no processes being allowed to run.

The same problem may occur if the parent and child process require only shared access to the resource, but an intervening process generates an intervening transaction request for the same resource. If the transaction request generated by the intervening process is a shared transaction, the resource-allocation algorithm simply grants simultaneous access to the intervening process and the child process, the child process finishes its task and terminates, and the parent process accesses the resource. If, however, the intervening process has generated a request for exclusive access to the resource, the resource-allocation algorithm will not grant access to the child process. Since it cannot access the resource, the child process will never complete its task, will never close, and will not terminate. Additionally, the intervening process will never receive access to the resource, resulting in deadlock. Accordingly, it would be advantageous to have a system that allows a parent process to transfer its place in a resource-access queue to its child process so that the child process may access the associated resource, complete its task, and terminate.

### SUMMARY OF THE INVENTION

The invention disclosed herein utilizes a resource-access key which is passed from a parent process to a child process. The resource-access key grants the child process the same priority of access to a system resource that was held by the parent process.

For example, a first process is placed in a resource-allocation queue, waiting for shared access to an associated resource. A second process, seeking exclusive access to the resource, is placed in the queue after the first process. When the first process reaches the top of the queue, a resource-allocation algorithm grants the first process shared access to the resource. Because the second process requires exclusive access to the resource, the resource-allocation algorithm refrains from granting access until the first process no longer needs access to the resource.

However, prior to releasing the resource, the first process spawns a third process (child process) that also requires shared access to the resource. When the third process is spawned, the first process passes a resource-access key to the third process indicating the current level of access to the resource granted by the resource-allocation algorithm. The third process then requests shared access to the resource. The resource-allocation algorithm identifies the resource-access key, allows the third process to bypass the resource-allocation queue, and grants the third process shared access to the resource. When the third process completes its processing task and terminates, control returns to the first process. When the first process completes its processing task, the first process terminates and control is passed to the second process. The resource-allocation algorithm then grants exclusive access to the resource to the second process.

Another aspect of the invention is that a process is given a resource-access key at inception predicated on the fact that a transaction request for a resource will most likely be a shared access request. For example, a first process is created with knowledge of a future need to access a resource and the type of access required. If the type of anticipated resource access is likely to be a shared access request, the first process is given a resource-access key indicating this. When the first process presents its resource-access request, the resource-allocation algorithm identifies the resource-access key, allows the first process to bypass the resource-allocation queue, and grants the first process shared access to the resource. Access to the resource is only denied if another process has been previously granted exclusive access.

Various other purposes and advantages of the invention will become clear from its description in the specification that follows and from the novel features particularly pointed out in the appended claims. Therefore, to the accomplishment of the objectives described above, this invention comprises the features hereinafter illustrated in the drawings, fully described in the detailed description of the preferred embodiments and particularly pointed out in the claims. However, such drawings and description disclose just a few of the various ways in which the invention may be practiced.

### BRIEF DESCRIPTION OF THE DRAWINGS

FIG. 1 is a block diagram illustrating a deadlock-prevention system including a resource, a resource-allocation algorithm, a resource allocation queue, a first process requesting shared access to the resource, a second process requesting exclusive access to the resource, and a third process spawned by the first process also requesting shared access to the resource.

FIG. 2 is a flow chart illustrating the process of passing access to a resource from a parent process to a spawned process, allowing it to bypass a resource-allocation queue.

### DESCRIPTION OF THE PREFERRED EMBODIMENTS

This invention is based on the idea of passing a resource-access key from a parent process to a spawned process indicating a current level of access to an allocated resource. The invention disclosed herein may be implemented as a method, apparatus or article of manufacture using standard programming or engineering techniques to produce software, firmware, hardware, or any combination thereof. The term “article of manufacture” as used herein refers to code or logic implemented in hardware or computer readable media such as optical storage devices, and volatile or non-volatile memory devices. Such hardware may include, but is not limited to, field programmable gate arrays (“FPGAs”), application-specific integrated circuits (“ASICs”), complex programmable logic devices (“CPLDs”), programmable logic arrays (“PLAs”), microprocessors, or other similar processing devices.

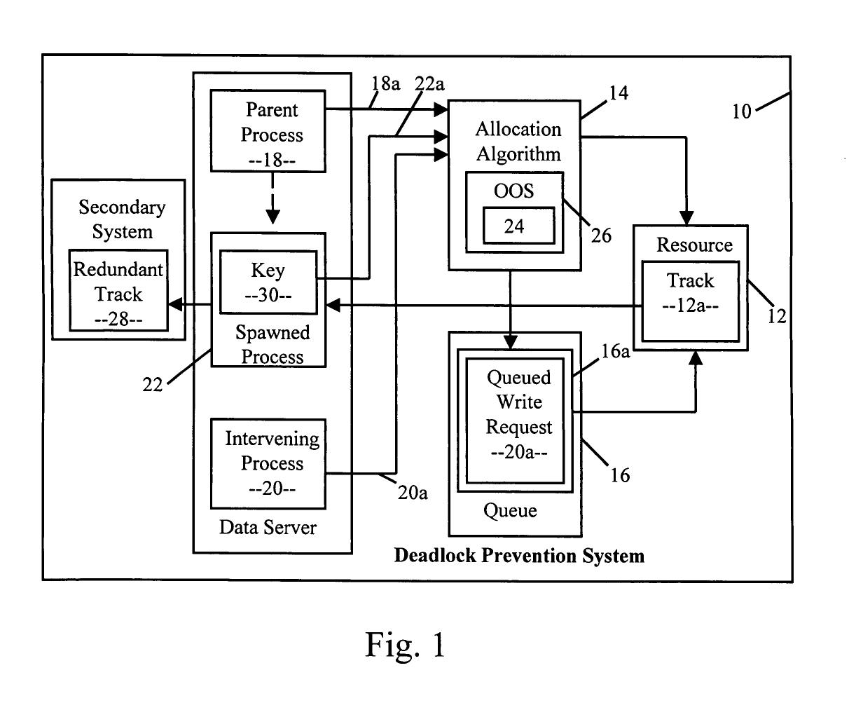

Referring to figures, wherein like parts are designated with the same reference numerals and symbols, FIG. 1 is a block diagram of a deadlock-prevention system 10 including a resource 12, a resource-allocation algorithm 14, a resource allocation queue 16, a first process 18 requesting shared access to the resource 12, a second process 20 requesting exclusive access to the resource 12, and a third process 22 spawned by the first process 18 also requesting shared access to the resource. In this embodiment of the invention, the resource 12 includes a data track 12a, the first process 18 includes a first write request 18a, the second process 20 includes a second write request 20a, and the third process 22 includes a read request 22a. The resource-allocation algorithm 14 is a process implemented within a computational device such as a field-programmable gate array (“FPGA”), application-specific integrated circuit (“ASIC”), programmable logic device (“PLD”), processor, or the like, or implemented by hardware such as integrated circuits (“ICs”). The resource-allocation queue 16 includes a data structure 16a residing within a memory device such as random-access memory (“RAM”).

In a peer-to-peer remote copy (“PPRC”) system, the first write request 18a is placed in the resource-allocation queue 16 by the resource-allocation algorithm 14. Once access has been granted to the resource 12, an out-of-synch bit 24 is set within an out-of-synch (“OOS”) bitmap 26, indicating that corresponding data in a redundant track 28 is now stale. The first process 18 spawns the third process 22, which is tasked with passing the newly written information to the redundant track 28. Accordingly, the third process 22 generates a read request 22a to read the newly written information from the data track 12a. The resource-allocation algorithm 14 identifies the second write request 20a as an exclusive transaction and withholds access until the first process 18 terminates.

Traditionally, the read request 22a would be placed in the resource-allocation queue 16 where it would languish behind the second write request 20a, producing deadlock. However, according to the invention, the first process 18 passes a resource-access key 30 to the third process 22 when it is spawned. In one embodiment of the invention, this resource-access key 30 includes information about the first processes' level of access to the resource 12 granted by the resource-allocation algorithm 14. When requesting access to the resource 12, the third process presents the resource-access key 30 to the resource-allocation algorithm 14. The resource-allocation algorithm identifies the resource-access key, allows the third process to bypass the resource-allocation queue 16, and grants the third process 22 the same level of access held by the first process 18.

In another embodiment of the invention, the first process 18 spawns the third process 22 with the expectation that the third process 22 will require shared-access to the resource 12. The resource-access key 30 includes a request for this shared access. When requesting access to the resource 12, the third process presents the resource-access key 30 to the resource-allocation algorithm 14. The resource-allocation algorithm identifies the resource-access key, allows the third process to bypass the resource-allocation queue 16, and grants the third process 22 shared access to the resource 12. Access to the resource is denied only if another process has been previously granted exclusive access to the resource that has not expired.

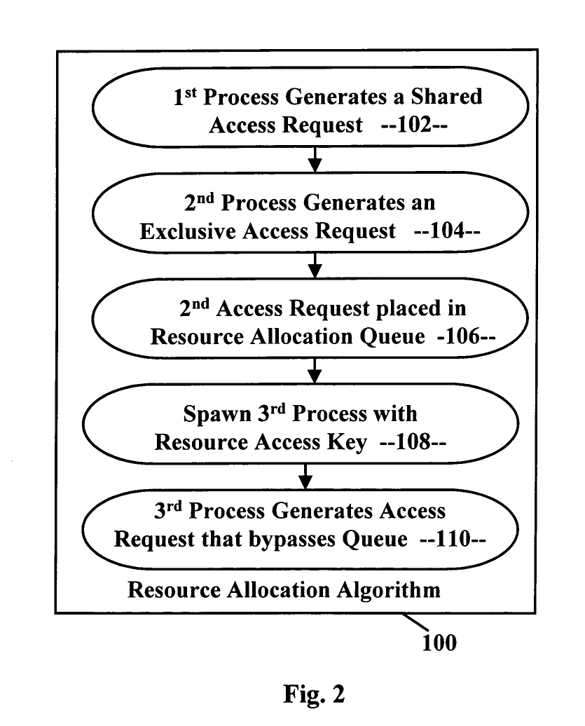

FIG. 2 is a flow chart illustrating a resource-allocation algorithm 100 implementing a process of passing resource access from a parent process 18 to a spawned process 22, allowing it to bypass a resource-allocation queue 16. In the optional step 102, a first process 18 generates a first write request 18a for writing new information to a data track 12a. This first write request 18a requires a request for shared access to the resource 12. In step 104, a second process 20 generates a second write request 20a, which requires an exclusive-access request to the resource 12. The second write request 20a is placed in the resource-allocation queue 14 in step 106. In step 108, the first process 18 creates a third process 22 with a resource-access key 30. The resource-access key 30 includes information about the first processes' level of access to the data track 12a. In step 110, the resource-allocation algorithm 14 identifies the resource-access key 30, allows the third process 22 to bypass the resource-allocation queue 16, and grants to the third process 22 shared access to the resource 12. Optionally, in step 108, the resource-access key 30 may include a shared-access request based on the anticipation by the first process 18 that the third process 22 will need shared-access to the resource 12.

Those skilled in the art of making deadlock prevention systems may develop other embodiments of the present invention. However, the terms and expressions which have been employed in the foregoing specification are used therein as terms of description and not of limitation, and there is no intention in the use of such terms and expressions of excluding equivalents of the features shown and described or portions thereof, it being recognized that the scope of the invention is defined and limited only by the claims which follow.

I claim:

1. A deadlock-prevention system, comprising:
a resource;
a resource-allocation queue;
a first process;
a second process spawned by the first process including a resource-access key, said resource-access key including a request for shared access to the resource; and
a resource-allocation algorithm adapted to identify the resource-access key, allow the second process to bypass the resource-allocation queue, and grant the second process shared access to the resource.

2. The deadlock-prevention system of claim 1, wherein the resource-access key includes a level of access passed by the first process to the second process.

3. The deadlock-prevention system of claim 1, wherein the request for shared access is created by the first process in anticipation that the second process would need the shared access to the resource.

4. The deadlock-prevention system of claim 1, wherein the resource is a data track.

5. The deadlock-prevention system of claim 4, wherein the first process includes a first write request.

6. The deadlock-prevention system of claim 5, wherein the second process includes a read request.

7. A method of preventing deadlock, comprising the steps of:
creating a spawned process including a resource-access key, said resource-access key including a request for shared access to a resource;
recognizing the resource-access key; and
granting the request for shared access, thereby bypassing a resource allocation queue.

8. The method of claim 7, wherein the resource-access key includes a level of access possessed by a parent process.

9. The method of claim 7, wherein the resource is a data track.

10. The method of claim 9, wherein the request for shared access is a request to write data to the data track.

11. The method of claim 7, wherein the request for shared access is created by a parent process in anticipation that the spawned process will need the request for shared access.

13. An article of manufacture including a data storage medium, said data storage medium including a set of machine-readable instructions that are executable by a processing device to implement an algorithm, said algorithm comprising the steps of:
creating a spawned process including a resource-access key, said resource-access key including a request for shared access to a resource;
recognizing the resource-access key; and
granting the request for shared access, thereby bypassing a resource allocation queue.

14. The article of manufacture of claim 13, wherein the resource-access key includes a level of access possessed by a parent process.

15. The article of manufacture of claim 13, wherein the resource is a data track.

16. The article of manufacture of claim 15, wherein the request for shared access is a request to write data to the data track.

17. The article of manufacture of claim 13, wherein the request for shared access is created by a parent process in anticipation that the spawned process will need the request for shared access.
